(19) United States
(12) Patent Application Publication
(10) Pub. No.: US 2022/0414419 A1
(43) Pub. Date: Dec. 29, 2022

(54) CONTROLLING AGENTS INTERACTING WITH AN ENVIRONMENT USING BRAIN EMULATION NEURAL NETWORKS

(71) Applicant: X Development LLC, Mountain View, CA (US)

(72) Inventors: Sarah Ann Laszlo, Mountain View, CA (US); David Andre, San Francisco, CA (US); Rednar Rosique Rodriquez, Mountain View, CA (US)

(21) Appl. No.: 17/362,446

(22) Filed: Jun. 29, 2021

(51) Int. Cl. G06N 3/00; G06N 3/08; G06N 3/04

(52) U.S. Cl. CPC G06N 3/008; G06N 3/006; G06N 3/08; G06N 3/0454

(57) ABSTRACT

In one aspect, there is provided a method performed by one or more data processing apparatus for selecting actions to be performed by an agent interacting with an environment, the method including, at each of multiple time steps, receiving an observation characterizing a current state of the environment at the time step, providing an input including the observation to an action selection neural network having a brain emulation sub-network with an architecture that is based on synaptic connectivity between biological neurons in a brain of a biological organism, processing the input including the observation characterizing the current state of the environment at the time step using the action selection neural network having the brain emulation sub-network to generate an action selection output, and selecting an action to be performed by the agent at the time step based on the action selection output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

SUMMARY

This specification describes a method performed by one or more data processing apparatus for selecting actions to be performed by an agent interacting with an environment using an action selection neural network having a brain emulation sub-network. The architecture of the brain emulation sub-network is determined based on synaptic connectivity between biological neurons in the brain of a biological organism.

According to a first aspect, there is provided a method performed by one or more data processing apparatus for selecting actions to be performed by an agent interacting with an environment, the method including, at each of multiple time steps, receiving an observation characterizing a current state of the environment at the time step, providing an input including the observation characterizing the current state of the environment at the time step to an action selection neural network having a brain emulation sub-network with an architecture that is based on synaptic connectivity between biological neurons in a brain of a biological organism, processing the input including the observation characterizing the current state of the environment at the time step using the action selection neural network having the brain emulation sub-network to generate an action selection output, and selecting an action to be performed by the agent at the time step based on the action selection output.

In some implementations, the environment is a simulated environment and the agent is a simulated agent interacting with the simulated environment.

In some implementations, the simulated agent is a simulated neuro-mechanical model of an organism.

In some implementations, the simulated agent is a simulated robot.

In some implementations, the action selection output includes a respective score for each action in a set of possible actions that can be performed by the agent.

In some implementations, selecting the action to be performed by the agent at the time step based on the action selection output includes determining a probability distribution over the set of possible actions based on the scores for the actions defined by the action selection output, and sampling the action to be performed by the agent at the time step from the probability distribution over the set of possible actions.

In some implementations, the method further includes receiving a respective reward for each of the multiple time steps, and training the action selection neural network based on the rewards using a reinforcement learning technique.

In some implementations, the reinforcement learning technique is a Q learning technique.

In some implementations, for each of the multiple time steps, processing the input including the observation characterizing the current state of the environment at the time step using the action selection neural network includes, processing the input including the observation using a first sub-network of the action selection neural network to generate a first sub-network output, processing the first sub-network output using the brain emulation sub-network to generate a brain emulation sub-network output, and processing the brain emulation sub-network output using a second sub-network of the action selection neural network to generate the action selection output.

In some implementations, parameter values of the brain emulation sub-network are initialized prior to training of the action selection neural network and are not adjusted during the training of the action selection neural network, and where at least some parameter values of the first sub-network, the second sub-network, or both, are adjusted during the training of the action selection neural network.

In some implementations, the action selection neural network includes multiple brain emulation sub-networks that each have a respective architecture that is based on synaptic connectivity between biological neurons in the brain of the biological organism.

In some implementations, the brain emulation neural network architecture is determined from a synaptic connectivity graph that represents the synaptic connectivity between the biological neurons in the brain of the biological organism.

In some implementations, the synaptic connectivity graph includes multiple nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

In some implementations, the synaptic connectivity graph is generated by multiple operations including obtaining a synaptic resolution image of at least a portion of the brain of the biological organism, and processing the image to identify: (i) multiple neurons in the brain, and (ii) multiple synaptic connections between pairs of neurons in the brain.

In some implementations, determining the brain emulation neural network architecture from the synaptic connectivity graph includes mapping each node in the synaptic connectivity graph to a corresponding artificial neuron in the brain emulation neural network architecture, and mapping each edge in the synaptic connectivity graph to a connection between a corresponding pair of artificial neurons in the brain emulation neural network architecture.

In some implementations, determining the brain emulation neural network architecture from the synaptic connectivity graph further includes instantiating a respective parameter value associated with each connection between a pair of artificial neurons in the brain emulation neural network architecture that is based on a respective proximity between a corresponding pair of biological neurons in the brain of the biological organism.

In some implementations, determining the brain emulation neural network architecture from the synaptic connectivity graph includes generating data defining multiple candidate graphs based on the synaptic connectivity graph, determining a respective performance measure for each candidate graph, including, for each candidate graph, instantiating an instance of an action selection neural network having a sub-network with an architecture that is specified by the candidate graph, and determining the performance measure for the candidate graph based on a task performance of an agent that accomplishes a task in an instance of an environment by performing actions selected using the instance of the action selection neural network having the sub-network with the architecture that is specified by the candidate graph, and selecting the brain emulation neural network architecture based on the performance measures.

In some implementations, selecting the brain emulation neural network architecture based on the performance measures includes identifying a best-performing candidate graph that is associated with a highest performance measure from among the multiple candidate graphs, and selecting the brain emulation neural network architecture to be an artificial neural network architecture specified by the best-performing candidate graph.

According to a second aspect, there are provided one or more non-transitory computer storage media storing instructions that when executed by one or more computers cause the one or more computers to perform the operations of the method of any preceding aspect.

According to a third aspect, there is provided a system including: one or more computers; and one or more storage devices communicatively coupled to the one or more computers, where the one or more storage devices store instructions that, when executed by the one or more computers, cause the one or more computers to perform the operations of the method of any preceding aspect.

Particular embodiments of the subject matter described in this specification can be implemented so as to realize one or more of the following advantages.

This specification describes an action selection system that can control an agent interacting with an environment to accomplish a goal (task) using an action selection neural network that includes a brain emulation sub-network having an architecture that is based on synaptic connectivity in the brain of the biological organism. The brain of the biological organism may be adapted by evolutionary pressures to be effective at solving certain tasks, and the action selection neural network, including the brain emulation sub-network, may inherit the capacity of the biological brain to effectively solve tasks. Accordingly, the system may be able to control the agent to accomplish a goal in a biologically-intelligent manner that is informed by evolution, which may be more effective than controlling the agent using a manually-specified neural network architecture.

The brain emulation sub-network of the action selection system may have a very large number of parameters and a highly recurrent architecture, i.e., as a result of being derived from the brain of a biological organism. Therefore, training the brain emulation sub-network using machine learning techniques may be computationally-intensive and prone to failure. Rather than training the brain emulation sub-network, the action selection system may utilize determined parameter values of the brain emulation sub-network based on the estimated strength of connections between corresponding neurons in the biological brain. The strength of the connection between a pair of neurons in the biological brain may characterize, e.g., the amount of information flow through a synapse connecting the neurons. In this manner, the action selection system may harness the capacity of the brain emulation sub-network, e.g., to generate representations that are effective for selecting actions to be performed by the agent, without requiring the brain emulation sub-network to be trained. By refraining from training the brain emulation sub-network, the action selection system may reduce consumption of computational resources, e.g., memory and computing power, during training of the action selection system. Furthermore, it may be possible to train the action selection system on fewer training iterations, e.g., on fewer interactions with the environment, until the agent is able to accomplish the goal.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of controlling an agent interacting with an environment using an action selection system.

FIG. 2 is a block diagram of an example action selection system.

FIG. 3 is a flow diagram of an example process for selecting actions to be performed by an agent interacting with an environment using an action selection system.

FIG. 4 is a block diagram of an example architecture selection system.

FIG. 5 is an example data flow for generating a synaptic connectivity graph from an image of the brain of a biological organism.

FIG. 6 is a block diagram of an example computer system.

Like reference numbers and designations in the various drawings indicate like elements.

### DETAILED DESCRIPTION

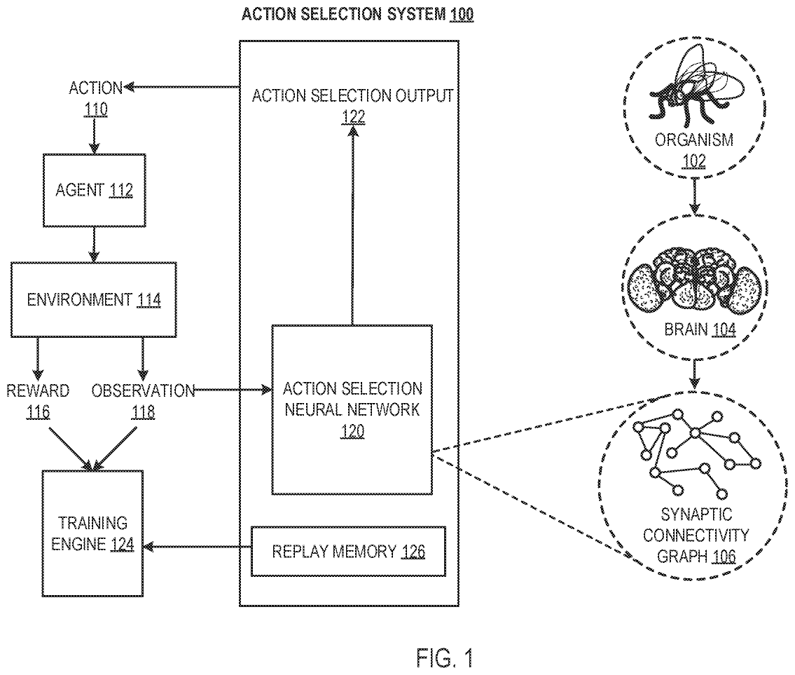

FIG. 1 shows an example of controlling an agent 112 interacting with an environment 114 using an action selection system 100. The action selection system 100 is an example of a system implemented as computer programs on one or more computers in one or more locations in which the systems, components, and techniques described below are implemented.

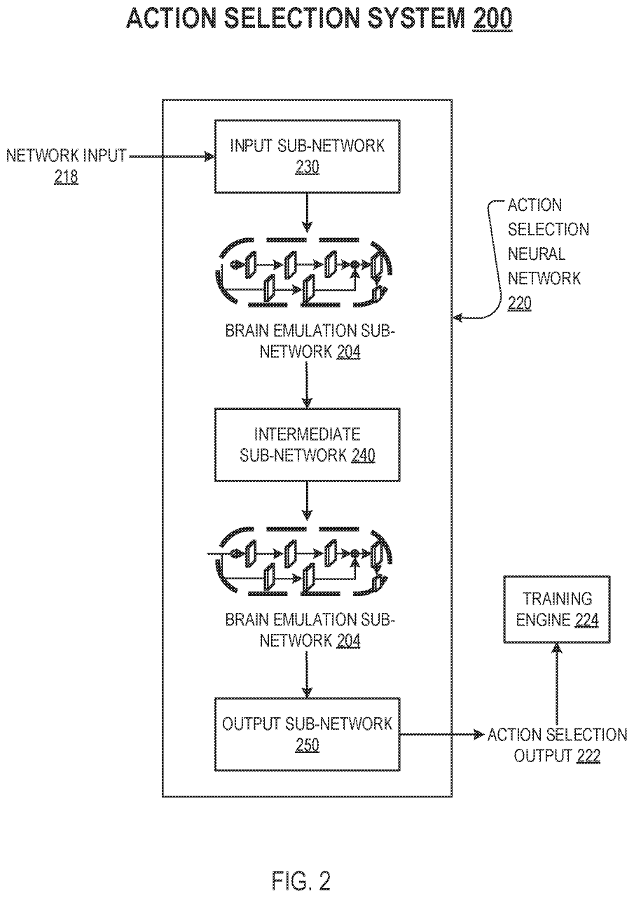

The system 100 includes an action selection neural network 120 that is based on the brain 104 of a biological organism 102, e.g., a worm, a fly, a mouse, a cat, or a human. In particular, as will be described in more detail below with reference to FIG. 2, the action selection neural network 120 can include a “brain emulation” sub-network, e.g., a neural network having an architecture that is based on a synaptic connectivity graph 106 that represents synaptic connectivity between neurons in the brain 104 of the biological organism 102.

The action selection neural network 120 can have a reservoir computing neural network architecture and can include one, or multiple, brain emulation sub-networks acting as one, or multiple, reservoirs, respectively. The network 120 can also include any other appropriate neural network layers and sub-networks (e.g., convolutional layers, fully connected layers, attention layers, etc.) that can be connected in any appropriate configuration (e.g., as a linear sequence of layers).

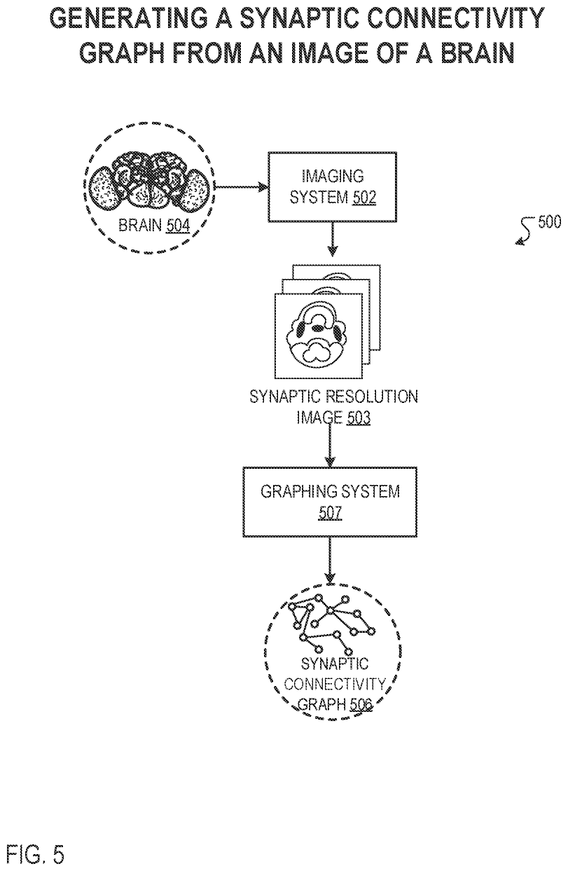

As will be described in more detail below with reference to FIG. 5, the synaptic connectivity graph 106 can be obtained from a synaptic resolution image of the brain 104 of the biological organism 102. As used throughout this document, a brain can refer to any amount of nervous tissue from a nervous system of a biological organism, and nervous tissue can refer to any tissue that includes neurons (i.e., nerve cells). An example of controlling the agent 112 interacting with the environment 114 using the action selection neural network 120 will be described in more detail next.

The action selection neural network 120 is configured to generate an action selection output 122 that characterizes the action 110 to be performed by the agent 112 interacting with the environment 114. More specifically, at each time step, the action selection neural network 120 processes an input into the action selection system 100 and generates an action selection output 122 characterizing the action 110. The action selection output 122 can include a respective score for each action in the set of possible actions. In one example, the system 100 can select the action 110 having the highest score, according to the action selection output 122, as the action 110 to be performed by the agent 112 at the time step. In another example, the system 100 can select the action 110 to be performed by the agent 112 in accordance with an exploration strategy, e.g., an ∈-greedy exploration strategy. In this example, the system 100 can select the action having a highest score (according to the action selection output 122) with probability 1−∈, and select an action randomly with probability ∈, where ∈ is a number between 0 and 1. In yet another example, the system 100 can sample a respective action from a set of possible actions in accordance with a probability distribution over the set of possible actions that is generated by, e.g., processing the action scores defined by the action selection output using a soft-max function. In some implementations, the action selection output 122 can directly define the action 110 to be performed by the agent 112 at the time step, e.g., by defining torques to be applied to the joints of a robotic agent.

The input into the action selection system 100 at each time step can be an observation 118, e.g., data characterizing the current state of the environment 114. In some implementations, the environment 114 can be a physical (real-world) environment, and the observation 118 can be obtained from one or more sensors positioned in the environment 114, e.g., sensors of the agent. In some implementations, the environment 114 can be a simulated, e.g., virtual, environment. The observation 118 (e.g., the current state of the environment 114), at the time step, can depend on the state of the environment 114 at the previous time step and the action 110 performed by the agent 112 at the previous time step. In other words, the action 110 performed by the agent 112 at the time step can influence the state of the environment 114 (e.g., the observation 118) at the subsequent time step.

The system 100 can select actions 110 to be performed by the agent 112 interacting with the environment 114 at each of multiple time steps in order to solve a particular task (e.g., to accomplish a goal). The system 100 can be configured to accomplish any variety of different goals. In one example, the goal can be e.g., navigating the agent 112 to a target location in the environment 114. In another example, the goal can be, e.g., controlling the agent 112 such that it locates an object in the environment 114. At each time step, the system 100 can receive a reward 116 (represented as, e.g., a numerical value) that is associated with the current state of the environment 114 and the action 110 of the agent 112 at the time step. The reward 116 can be associated with any event in, or aspect of, the environment 114, and can indicate whether the agent 112 has accomplished the goal. The reward 116 can characterize a progress of the agent 112 towards accomplishing a goal (or a task). In one example, the reward 116 can be, e.g., zero at each time step before the agent accomplishes a goal, and 1 (or other positive value) at the time step when the agent 112 accomplishes the goal.

After the system 100 generates the action selection output 122, the agent 112 can interact with the environment 114 by performing the corresponding action 110, and the system 100 can receive a reward 116 based on the interaction. Further, the system 100 can generate an experience tuple characterizing the interaction of the agent 112 with the environment 114 at the time step, and store the experience tuple in the replay memory 126. An “experience tuple” for a time step refers to data that characterizes the interaction of the agent 112 with the environment 114 at the time step. The replay memory 126 can be implemented as e.g., a logical data storage area or physical data storage device.

For example, an experience tuple for a previous time step can include respective embeddings (representations) of: (i) the observation 118 at the previous time step, (ii) the action 110 performed by the agent 112 at the previous time step, (iii) the reward 116 received at the previous time step after the action 110 has been performed, and (iv) the observation 118 at the next time step that resulted from the action 110 performed by the agent 112 at the previous time step. An “embedding” refers to, e.g., an ordered collection of numerical values such as, e.g., a vector or a matrix of numerical values. The replay memory 126 can store a respective experience tuple for each time step before the current time step. In some implementations, the replay memory 126 can store a predetermined (e.g., finite) number of experience tuples (e.g., 10, 1000, 100,000, experience tuples, etc.). For example, once the number of experience tuples stored in the memory 126 reaches the predetermined number, each time a new experience tuple is generated at the current time step, the experience tuple corresponding to the earliest time step that is stored in the replay memory 126 can be erased from the memory 126, and the experience tuple for the current time step can be added to the memory 126.

A training engine 124 can train the action selection neural network 120 using any appropriate reinforcement learning technique, e.g., a Q learning technique, an actor critic technique, or a policy gradient technique In some implementations, the training engine 124 can train the action selection neural network 120 by using the experience tuples stored in the replay memory 126 as training data. As mentioned above, the training data can be generated by, e.g., receiving an observation characterizing the current state of the environment at the time step, selecting an action according to an action selection output at the time step (e.g., using ∈-greedy exploration strategy), performing the corresponding action in the environment, receiving the associated reward, receiving an observation characterizing the state of the environment after the action has been performed, and saving the experience tuple in the replay memory 126 for each time step.

During training, the training engine 124 can randomly sample a batch of experience tuples from the memory 126 and provide, e.g., the observation included in each experience tuple as an input to the action selection neural network 120. Randomly selecting a number of experience tuples from the replay memory 126 allows for diversification of the training data and minimizes any correlations that may exist between sequential observation-action pairs (e.g., sequential experience tuples). The network 120 can process the input and generate a prediction for a Q-value which is the expected cumulative reward over multiple time steps, given a particular state-action pair.

At each training iteration, the network 120 can process, e.g., the observation characterizing the current state of the environment and the action at the time step, stored in an experience tuple, and predict Q-value for the state-action pair. Based on the prediction and the reward stored in the experience tuple, the training engine 124 can compute a corresponding loss function (e.g., mean squared error loss function) characterizing a difference between the observed Q-value and the predicted Q-value, and adjust the parameter values of the action selection neural network 120 at each training iteration to, e.g., optimize a reinforcement learning objective function. The training engine 124 can determine the gradients of the reinforcement learning objective function with respect to the action selection neural network 120 parameters, e.g., using backpropagation techniques, or any other appropriate gradient descent, constraint satisfaction, or optimization technique. Training the action selection neural network 120 using reinforcement learning techniques can encourage the selection of actions that maximize a cumulative measure of rewards (e.g., a time discounted sum of rewards) that are received as a result of using the action selection neural network 120 to control the agent 112.

In some cases, the action selection system 100 can be used to control the interactions of the agent 112 with a simulated environment 114, and the training engine 124 can train the parameters of the action selection neural network 120 (e.g., using reinforcement learning techniques) based on the interactions of the agent 112 with the simulated environment 114. After the action selection neural network 120 is trained based on the interactions of the agent 112 with the simulated environment 114, the agent 112 can be deployed in a real-world environment, and the trained action selection neural network 120 can be used to control the interactions of the agent 112 with the real-world environment. Training the action selection neural network 120 based on interactions of the agent 112 with a simulated environment 114 (i.e., instead of a real-world environment) can avoid wear-and-tear on the agent 112 and can reduce the likelihood that, by performing poorly chosen actions, the agent 112 can damage itself or aspects of its environment. Example applications of the action selection system 100 will be described in more detail next.

In some implementations, the environment can be a real-world physical environment and the agent can be a real-world physical agent, e.g., an autonomous vehicle, a robot, or a drone. For example, the agent can be a drone interacting with the environment to accomplish a goal, e.g., to safely navigate to a particular destination, or land at a specified landing site. In another example, the agent can be a robot, and the goal can be, e.g., to move an object of interest to a specified location in the environment, to physically manipulate an object in the environment in a particular manner, etc.

In these implementations, the environment can be any appropriate (real or simulated) physical environment, and the agent can be any appropriate physical agent. The observations can include data obtained from one or more sensors, e.g., image data, video data, audio data, odor data, temperature data, sensed electronic signals, current, voltage, power, point cloud data (e.g., generated by a lidar or radar sensor), position and velocity data (e.g., characterizing the motion of an agent), magnetic field data, and any other appropriate data or a combination thereof. The sensors can be positioned anywhere in the environment and/or can be coupled to the agent in any appropriate manner. The observations can further include any appropriate data characterizing the state of the robot, vehicle, drone, or any other appropriate physical agent, such as, e.g., joint position, joint velocity, joint force, torque or acceleration, gravity-compensated torque feedback, global or relative pose of an item held by the agent, the position, linear or angular velocity, force, torque, acceleration, global or relative pose of one or more parts of the agent, etc. The observations can further include, e.g., one or more of images, object position data, and sensor data to capture observations as the agent interacts with the environment, for example sensor data from an image, distance, or position sensor or from an actuator.

The action to be performed by the physical agent can be any appropriate action. In one example, the action can be an input that can control the state of the physical agent such as, e.g., torques for the joints of the agent or higher-level control commands, or the autonomous or semi-autonomous land or air or sea vehicle, e.g., torques to the control surface or other control elements of the vehicle or higher-level control commands.

In other words, the actions can include for example, position, velocity, or force/torque/acceleration data for one or more joints of the agent or parts of another mechanical agent. Actions can additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions can include actions to control navigation, e.g., steering and movement e.g., braking and/or acceleration of the vehicle.

In some implementations, the environment can be a simulated (e.g., virtual) environment, and the agent can be a simulated (e.g., virtual) agent, e.g., a virtual robot in a virtual workcell. The virtual robot can interact with a virtual environment to accomplish a goal, e.g., pick up and hold a virtual object, place a virtual object in a specified position/location in the virtual workcell, manipulate the joints of the virtual robot so as to reach a particular point in the virtual workcell, etc. Generally, in the case of the simulated environment, the observations can include simulated versions of one or more of the aforementioned observations, or types of observations, and the actions can include simulated versions of the one or more of the aforementioned actions, or types of actions.

In another example, the simulated agent can be a high fidelity neuromechanical simulation of a fly (or other biological organism) interacting with a simulated environment, and the actions can include, e.g., any action relating to a behavior of the fly in the environment, e.g., coordinated movement of joints of the fly. As will be described in more detail below with reference to FIG. 2, the action selection neural network 120 can include a brain emulation sub-network having an architecture that is based on synaptic connectivity in the brain of the biological organism. Generally, the brains of biological organisms may be adapted by evolutionary pressures to be effective at performing certain tasks, e.g., classifying objects, generating robust object representations, and performing actions that attempt to, e.g., maximize favorable outcomes.

The brain emulation neural network, derived from the brain of the biological organism, may share this capacity to be effective at performing actions that maximize favorable outcomes. Therefore, by using the brain emulation neural network, it may be possible to control the fly in a biologically-intelligent manner, e.g., in a way that is inherently informed by evolutionary processes. By contrast, it may be difficult to achieve the same level of control by using, e.g., a manually-specified neural network architecture. Example high fidelity neuromechanical simulation of a fly is described with reference to: V. Rios, et al., “NeuroMechFly, a neuromechanical model of adult Drosophila melanogaster,” bioRxiv doi:10.1101/2021.04.17.440214 (2021). In some implementations, the architecture of the brain emulation sub-network can be derived from the brain of a first biological organism, and the action selection neural network 120 can be used to control a simulated copy of the first biological organism, or a second, different, biological organism.

In some implementations, the agent can control items of equipment in a physical real-world environment, e.g., in a data center or grid mains power or water distribution system, or in a manufacturing plant or service facility. The observations can then relate to operation of the plant or facility, the goal can be, e.g., increased efficiency, and the actions can include any actions relating to controlling any aspect of the operation of the plant or facility.

In some implementations, the agent can interact with a physical real-world environment so as to manage the distribution of tasks across computing resources, e.g., on a mobile device and/or in a data center. The actions can include, e.g., assigning tasks to particular computing resources, and the goal can include, e.g., minimizing the time required to complete a set of tasks using specified computing resources.

In some implementations, the simulated environment can be a video game and the agent can be a simulated user playing the video game.

In some implementations, the agent can be a simulated self-driving vehicle, a simulated drone, or a simulated robot, that is configured to operate in unique environments that are different from the environment on Earth, e.g., the environment on other planets, such as Mars. The environment can be a simulated environment having simulated aspects that correspond to the physical aspects found on Mars, e.g., a particular atmospheric composition, strength of gravitational force, geological features, etc. The simulated robot can interact with the simulated Martian environment, and the actions can include, e.g., navigation in the simulated environment. After training of the action selection system 100 on selection actions 122 to be performed by the simulated robot 112 in the simulated Martian environment 114, the corresponding physical robot can be deployed in the physical Martian environment and controlled by using the trained action selection system 100 to perform the tasks. Training the simulated robot in the simulated environment, as opposed to training the physical robot in the real-world physical Martial environment, can help to ensure that the robot is appropriately trained before undertaking significant risks and costs involved in deploying the physical robot on Mars.

Optionally, in any of the above implementations, the observation at any given time step can include data from a previous time step that can be beneficial in characterizing the environment, e.g., the action performed at the previous time step, the reward received at the previous time step, sensor data characterizing the environment at the previous time step, and so on.

FIG. 2 is a block diagram of an example action selection system 200. The action selection system 200 is an example of a system implemented as computer programs on one or more computers in one or more locations in which the systems, components, and techniques described below are implemented. The action selection system 200 can be, e.g., the action selection system 100 in FIG. 1.

The system 200 can include an action selection neural network 220 (e.g., the action selection neural network 120 in FIG. 1) that can be implemented as, e.g., a reservoir computing neural network. Generally, a reservoir computing neural network can include one or more neural network layers that are trained, e.g., including an input layer and an output layer, and a reservoir sub-network, where the values of the reservoir sub-network parameters can be, e.g., static (i.e., not adjusted) during training of the reservoir computing neural network. The values of the parameters of the other neural network layers, e.g., the input layer and the output layer, can be adjusted during training of the reservoir computing neural network.

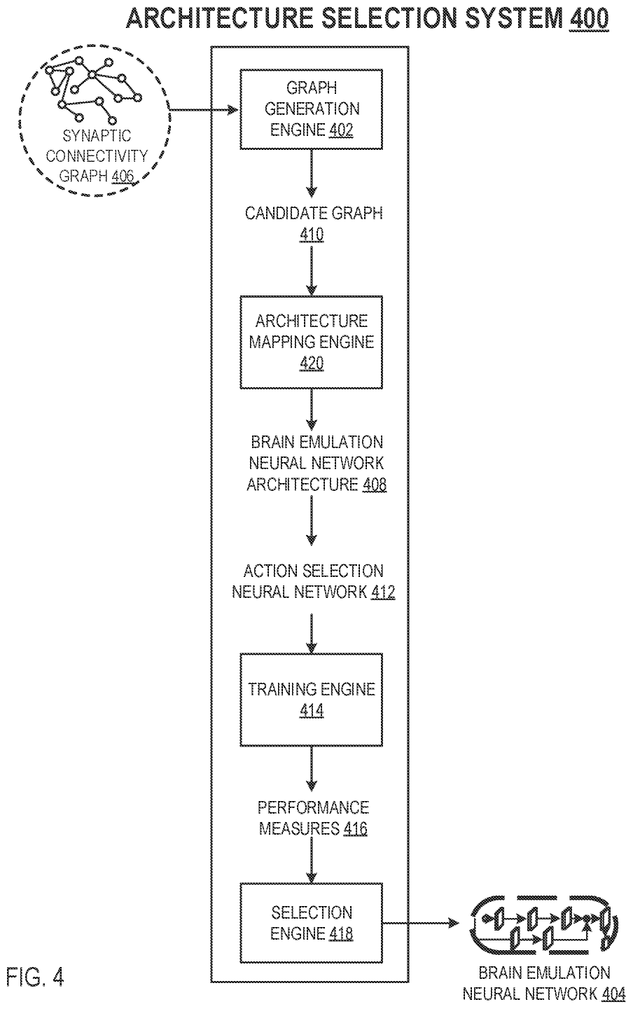

The action selection neural network 220 can include (i) a brain emulation sub-network 204 acting as the reservoir, (ii) an input sub-network 230, and (iii) an output sub-network 250. In some implementations, the network 220 can include a sequence of multiple different (or the same) brain emulation sub-networks 204 each generated by, e.g., the architecture selection system described with reference to FIG. 4. In some implementations, each brain emulation-sub network 204 can have an architecture specified by synaptic connectivity in the whole of the brain of the biological organism. In some implementations, each brain emulation sub-network 204 can have an architecture that is specified by synaptic connectivity in different regions of the brain of the biological organism. For example, the action selection neural network 220 can include a brain emulation sub-network 204 for each of the regions of the brain of the biological organism that collectively represent synaptic connectivity in the whole of the brain of the biological organism.

The brain emulation sub-networks 204 can be interleaved with other artificial neural network layers and/or sub-networks (e.g., an intermediate sub-network 240) having parameter values that are trained during the training of the reservoir computing neural network 220, i.e., in contrast to the parameter values of the brain emulation sub-networks 204. The other artificial neural networks in the action selection system 200 (e.g., the input sub-network 230, the intermediate sub-network 240, and the output sub-network 250) can have any appropriate neural network architecture that enables them to perform their described function, e.g., can include any appropriate number of neural network layers of any appropriate type (e.g., convolutional layers, fully connected layers, attention layers, etc.) connected in any appropriate configuration (e.g., as a linear sequence of layers). The aforementioned configuration of the action selection neural network 220 is provided for illustrative purposes only, and the action selection neural network 220 can include any number of brain emulation sub-networks having any appropriate architecture, coupled to any number of neural network layers and/or sub-networks and connected in any appropriate configuration.

The output of a first sub-network in the action selection neural network (e.g., the input sub-network 230 or the intermediate sub-network 240) can be provided as an input to a brain emulation sub-network in the action selection neural network in a variety of possible ways. For example, the first sub-network can include a respective connection from each artificial neuron in an output layer of the first sub-network to each of one or more artificial neurons of the brain emulation sub-network that are designated as input neurons. In some cases, the output layer of the first sub-network is fully-connected to the neurons of the brain emulation sub-network, i.e., such that the first sub-network includes a respective connection from each artificial neuron in the output layer of the first sub-network to each artificial neuron in the brain emulation sub-network.

The output of a brain emulation sub-network in an action selection neural network can be provided as an input to a second sub-network in the action selection neural network (e.g., the intermediate sub-network 240 or the output sub-network 250) in a variety of possible ways. For example, the second sub-network can include a respective connection from each artificial neuron in the brain emulation sub-network that is designated as an output neuron to each of one or more artificial neurons in the input layer of the second sub-network. In some cases, the artificial neurons of the brain emulation sub-network are fully-connected to the input layer of the second sub-network, i.e., such that the second sub-network includes a respective connection from each artificial neuron in the brain emulation sub-network to each artificial neuron in the input layer of the second sub-network.

The action selection neural network 220 can be configured to receive a network input 218 and generate an action selection output 222. As mentioned above with reference to FIG. 1, the input 218 can be an observation characterizing the current state of the environment at the time step. More specifically, the input sub-network 218 can process the network input 218 in accordance with a set of parameters of the input sub-network 218 and generate an embedding of the input 218. An “embedding” refers to, e.g., an ordered collection of numerical values such as, e.g., a vector or matrix of numerical values. The embedding generated by the input sub-network 230 can be provided to the brain emulation sub-network 204.

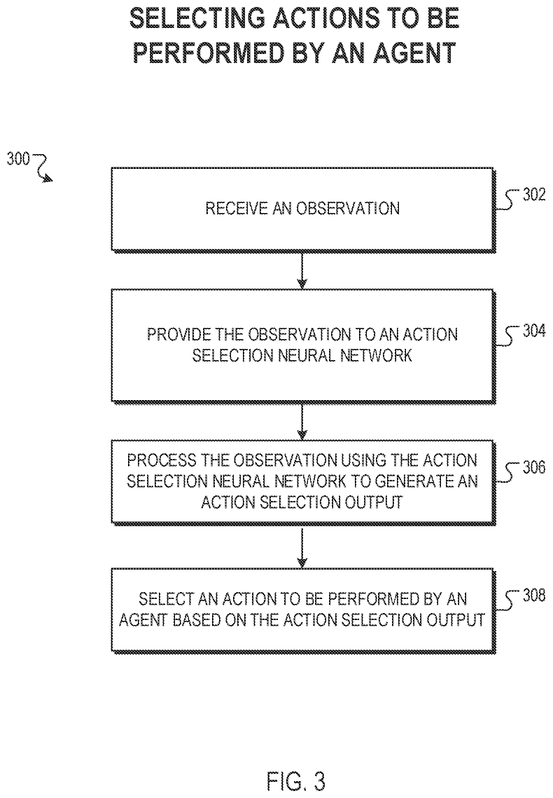

As described above, the brain emulation sub-network 204 can have an architecture that is specified by synaptic connectivity between neurons in the brain of a biological organism. As will be described in more detail below with reference to FIG. 3, an architecture search system can select a brain emulation sub-network architecture for inclusion in the action selection neural network 220 based on the synaptic connectivity graph. In some implementations, multiple different architectures of the brain emulation sub-network can be selected by the architecture selection system, and each architecture can be included in the action selection neural network 220 as a respective reservoir, e.g., each of the reservoirs in the action selection neural network 220 can be implemented as a brain emulation sub-network 204 having a different architecture. In some implementations, the same brain emulation sub-network architecture can be included in the action selection neural network 220 as multiple reservoirs, e.g., each reservoir can be implemented as a brain emulation sub-network 204 having the same architecture.

Because the brain emulation sub-network architecture is derived from synaptic connectivity between neurons in the brain of the biological organism, in some cases, the brain emulation sub-network can have an architecture that is more complex than the architecture of the other components of the system 200, such as, e.g., the input sub-network 230, the intermediate sub-network 240, and the output sub-network 250. Specifically, the architecture of the brain emulation sub-network 204 can include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output to the second neuron, and the second neuron provides its output to the first neuron) would form a recurrent loop. In some implementations, the other components of the system such as the input sub-network 230, the intermediate sub-network 240, and the output sub-network 250, and any other appropriate components, can have a recurrent architecture, e.g., can include one or more recurrent neural network layers, such as long short-term memory (LSTM) layers.

The brain emulation sub-network 204 can process the embedding of the network input 218 (generated by the input sub-network 230) in accordance with a set of parameters of the brain emulation sub-network 204, to generate an alternative representation of the network input 218. In some implementations, the brain emulation sub-network 204 can process the embedding over multiple (internal) time steps. In particular, at each time step, the brain emulation sub-network 204 can process: (i) the embedding of the network input 218, and (ii) any outputs generated by the brain emulation sub-network 204 at the preceding time step, to generate the alternative representation for the time step. The number of time steps over which the brain emulation sub-network 204 processes the embedding can be a predetermined hyper-parameter of the action selection neural network 220. The alternative representation generated at the final time step can be provided to the intermediate sub-network 240 (or to the output sub-network 250, in the case where the action selection neural network 220 includes only one brain emulation sub-network 204).

The intermediate sub-network 240 can generate an embedding of the alternative representation, received from the brain emulation sub-network 204, in accordance with a set of parameters of the intermediate sub-network 240. The embedding, generated by the intermediate sub-network 240, can be provided to the second brain emulation sub-network 204 (or to the output sub-network 250), that can process the embedding in accordance with a set of parameters of the second brain emulation sub-network 204 and generate an alternative representation of the embedding, in a similar way as described above.

The alternative representation of the embedding can be provided to the output sub-network 250. The output sub-network 250 can process the output generated by the second brain emulation sub-network 204 (i.e., the alternative representation) in accordance with a set of parameters of the output sub-network 250 and generate a corresponding action selection output 222, e.g., an output that characterizes an action to be performed by an agent. As described above, in one example, the action selection output 222 can include a respective score corresponding to each action in a set of possible actions. In another example, the action selection output can directly define an action to be performed by the agent.

After generating the action selection output 222, the action selection system 200 can use the output to control the agent interacting with an environment. For example, the agent can be a physical drone interacting with a physical environment, and the action selection system 200 can control aspects of operation of the drone, e.g., a wing speed and position and/or direction of motion of the drone. For example, if the action selection output 222 defines a respective speed for each propeller of the drone, then the action selection system 200 can change the respective speed of each propeller of the drone to match the speeds defined by the action selection output 222, e.g., by generating control signals for each of the propellers. As another example, if the action selection output 222 defines an adjustment to the flight direction of the drone, then the action selection system 200 can adjust the propeller speeds of the drone to adjust the flight direction.

In some implementations, after generating the action selection output 222, the action selection system 200 can use the output to control a simulated agent interacting with a simulated environment. For example, the simulated agent can be a high fidelity neuromechanical simulation of a fly, and the action selection system 200 can control aspects of “behavior” of the fly, e.g., location/direction of motion, grooming, etc. For example, if the action selection output 222 defines a respective speed of movement of the simulated fly (wing speed, etc.), then the action selection system 200 can change the respective speed of movement of the simulated fly to match the speed defined by the action selection output 222. Example high fidelity neuromechanical simulation of a fly is described with reference to: V. Rios, et al., “NeuroMechFly, a neuromechanical model of adult Drosophila melanogaster,” bioRxiv doi:10.1101/2021.04.17.440214 (2021)

The action selection system 200 can further include a training engine 224 (e.g., the training engine 124 in FIG. 1), that is configured to train the action selection system 200. Training the system 200 from end-to-end (i.e., training both the parameters of one or more of the brain emulation sub-networks 204 and the parameters of the other neural network layers/sub-networks 230, 240, 250) can be difficult due to the complexity of the architecture of the brain emulation sub-network. In particular, the brain emulation sub-network can have a very large number of trainable parameters and can have a highly recurrent architecture (i.e., an architecture that includes loops, as described above). Therefore, training the system 200 from end-to-end using machine learning training techniques can be computationally-intensive and the training can fail to converge, e.g., if the values of the parameters of the system 200 oscillate rather than converge to fixed values. Even in cases where the training of the system 200 converges, the performance of the system 200 (e.g., measured by prediction accuracy) can fail to achieve an acceptable threshold. For example, the large number of parameters of the system 200 can overfit the limited amount of training data.

Rather than training the entire system 200 from end-to-end, the training engine 224 can optionally only train the parameters of the input 230, output 250, and/or intermediate 240 layers/sub-networks, while leaving the parameters of the one or more brain emulation sub-networks 204 fixed during training. The parameters of the brain emulation sub-network 204 can be determined before the training of the system 200 based on the weight values of the edges in the synaptic connectivity graph, as described with reference to FIG. 5. Optionally, the weight values of the edges in the synaptic connectivity graph can be transformed (e.g., by additive random noise) prior to being used for specifying parameters of the brain emulation sub-network 204. This training procedure enables the system 200 to take advantage of the highly complex and non-linear behavior of the brain emulation sub-network 204 in performing prediction tasks while obviating the challenges of training the brain emulation sub-network 204.

The training of the system 200 can be performed using any appropriate reinforcement learning or supervised learning technique, e.g., a Q learning technique or an actor critic technique. For example, the sub-networks 230, 240, 250 can be trained using reinforcement learning based on a reward signal that characterizes a progress of the agent in accomplishing a task. Training the action selection system 200 using the reinforcement learning technique can encourage the selection of actions that maximize a cumulative measure of rewards (e.g., a time discounted sum of rewards) that are received as a result of using the action selection neural network 200 to control the agent.

The training engine 224 can train the action selection neural network 220 on a set of training data that includes multiple trajectories that characterize interaction of the agent with an environment over a sequence of time steps. In particular, each trajectory can define, for each time step in a sequence of time steps: (i) an observation characterizing the state of the environment at the time step (e.g., the observation 118 in FIG. 1), (ii) a reward received at the time step (e.g., the reward 116 in FIG. 1), and (iii) optionally, a target action to be performed by the agent at the time step (e.g., the action 110 in FIG. 1). The training data can also include one or multiple experience tuples stored in a replay memory (e.g., the replay memory 126 in FIG. 1), as described above with reference to FIG. 1.

At each of multiple training iterations, the training engine 224 can sample a batch (i.e., set) of one or more trajectories from the training data, and process the respective observation (e.g., the network input 218) for each time step in each trajectory using the action selection neural network 220 to generate a corresponding action selection output 222, e.g., the action selection output. The training engine 224 can determine gradients of an objective function with respect to the action selection neural network 220 parameters, where the objective function depends on the respective action selection output generated by the action selection neural network 220 for each time step in each trajectory. For example, for reinforcement learning training, the objective function can include, e.g., a Q learning objective function that further depends on the reward received at the time step. As another example, for imitation learning training, the objective function can include, e.g., a cross-entropy objective function that measures a cross-entropy error between: (i) the action selection output generated by the action selection neural network 220 for the time step, and (ii) the target action for the time step.

The training engine 224 can use the gradients of the objective function to update the values of the action selection neural network 220 parameters (in particular, the parameters of the input, output and/or intermediate sub-networks) to, e.g., optimize the objective function. The training engine 224 can determine the gradients of the objective function with respect to the action selection neural network 220 parameters, e.g., using backpropagation or Hebbian learning techniques. The training engine 224 can use the gradients to update the action selection neural network 220 parameters using the update rule of a gradient descent optimization algorithm, e.g., Adam or RMSprop.

The training engine 224 can use any of a variety of regularization techniques during training of the action selection neural network 220. For example, the training engine 224 can use a dropout regularization technique, such that certain artificial neurons of the one or more of the brain emulation sub-networks 204 are “dropped out” (e.g., by having their output set to zero) with a non-zero probability p>0 each time any of the one or more of brain emulation sub-networks 204 processes an input. Using the dropout regularization technique can improve a performance of the trained action selection neural network 220, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 224 can regularize the training of the action selection neural network 220 by including a “penalty” term in the objective function that measures the magnitude of the parameter values of either, some, or all of: the input sub-network 230, the intermediate sub-network 240, and the output sub-network 250. The penalty term can be, e.g., an L_1 or L_2 norm of the parameter values of either, some, or all of the sub-networks.

In some cases, the values of the intermediate outputs of the brain emulation sub-network 204 can have large magnitudes, e.g., as a result of the parameter values of the brain emulation sub-network 204 being derived from the weight values of the edges of the synaptic connectivity graph. Therefore, to facilitate training of the action selection neural network 204, batch normalization layers can be included between the layers of the brain emulation sub-network 204, which can contribute to limiting the magnitudes of intermediate outputs generated by the brain emulation sub-network 204. Alternatively or in combination, the activation functions of the neurons of the brain emulation sub-network 204 can be selected to have a limited range. For example, the activation functions of the neurons of the brain emulation sub-network 204 can be selected to be sigmoid activation functions with range given by [0,1].

FIG. 3 is a flow diagram of an example process 300 for selecting actions to be performed by an agent interacting with an environment using an action selection system. For convenience, the process 300 will be described as being performed by a system of one or more computers located in one or more locations. For example, an action selection system, e.g., the action selection system 100 of FIG. 1, or the action selection system 200 of FIG. 2, appropriately programmed in accordance with this specification, can perform the process 300.

At each of multiple time steps, the system receives an observation characterizing a current state of the environment at the time step (302). As described above, the environment can be a simulated environment and the agent can be a simulated agent (e.g., a neuro-mechanical model of an organism or a robot) interacting with the simulated environment.

At each of multiple time steps, the system provides an input including the observation characterizing the current state of the environment at the time step to an action selection neural network (304). The action selection neural network includes a brain emulation sub-network with an architecture that is based on synaptic connectivity between biological neurons in a brain of a biological organism. In some implementations, the action selection neural network can include multiple brain emulation sub-networks that each have a respective architecture that is based on synaptic connectivity between biological neurons in the brain of the biological organism.

The brain emulation neural network architecture can be determined from a synaptic connectivity graph that represents the synaptic connectivity between the biological neurons in the brain of the biological organism. As described below with reference to FIG. 5, the synaptic connectivity graph can include multiple nodes and edges, each edge can connect a pair of nodes, each node can correspond to a respective neuron in the brain of the biological organism, and each edge connecting a pair of nodes can correspond to a synaptic connection between a pair of biological neurons in the brain of the biological organism. In some implementations, determining the brain emulation neural network architecture from the synaptic connectivity graph can include mapping each node in the graph to a corresponding artificial neuron in the architecture, mapping each edge in the graph to a connection between a corresponding pair of artificial neurons in the architecture, and instantiating a respective parameter value associated with each connection between a pair of artificial neurons in the architecture that is based on a respective proximity between a corresponding pair of biological neurons in the brain of the biological organism.

In some implementations, determining the brain emulation neural network architecture from the synaptic connectivity graph can include generating data defining multiple candidate graphs based on the synaptic connectivity graph, determining a respective performance measure for each candidate graph, and selecting the brain emulation neural network architecture based on the performance measures. As described in more detail below with reference to FIG. 4, determining the performance measure can include instantiating an instance of an action selection neural network having a sub-network with an architecture that is specified by the candidate graph, and determining the performance measure for the candidate graph based on a task performance of an agent that accomplishes a task in an instance of an environment by performing actions selected using the instance of the action selection neural network having the sub-network with the architecture that is specified by the candidate graph. Selecting the brain emulation neural network architecture based on the performance measures can include identifying a best-performing candidate graph that is associated with a highest performance measure from among multiple candidate graphs and selecting the brain emulation neural network architecture to be an artificial neural network architecture specified by the best-performing candidate graph.

The system processes the input including the observation characterizing the current state of the environment at the time step using the action selection neural network having the brain emulation sub-network to generate an action selection output (306). The action selection output can include a respective score for each action in a set of possible actions that can be performed by the agent. For each of multiple time steps, processing the input including the observation characterizing the current state of the environment at the time step using the action selection neural network can include processing the input using a first sub-network of the action selection neural network to generate a first sub-network output, processing the first sub-network output using the brain emulation sub-network to generate a brain emulation sub-network output, and processing the brain emulation sub-network output using a second sub-network of the action selection neural network to generate the action selection output. The parameter values of the brain emulation sub-network can be initialized prior to training of the action selection neural network and not adjusted during training of the action selection neural network, and at least some parameter values of the first sub-network, the second sub-network, or both, can be adjusted during training of the action selection neural network.

The system selects an action to be performed by the agent at the time step based on the action selection output (308). As described in more detail above with reference to FIG. 1, selecting the action can include determining a probability distribution over the set of possible actions based on the scores for the actions defined by the action selection output, and sampling the action to be performed by the agent at the time step from the probability distribution over the set of possible actions. In some implementations, the system can receive a respective reward for each of the multiple time steps and train the action selection neural network based on the rewards using a reinforcement learning technique (e.g., a Q learning technique).

FIG. 4 is an example architecture selection system 400. The architecture selection system 400 is an example of a system implemented as computer programs on one or more computers in one or more locations in which the systems, components, and techniques described below are implemented.

The system 400 is configured to search a space of possible neural network architectures to identify the neural network architecture of a brain emulation neural network 404 to be included in an action selection neural network (e.g., the network 120 in FIG. 1 or the network 220 in FIG. 2). In some implementations, the system 400 can identify multiple brain emulation neural networks 404 to be included in the action selection neural network. The action selection neural network processes a network input (e.g., an observation characterizing the current state of the environment at the time step) and generates an action selection output that characterizes an action to be performed by an agent interacting with an environment at the time step. Example agents and environments are described above with reference to FIG. 1.

The system 400 can seed the search through the space of possible neural network architectures using a synaptic connectivity graph 406 representing synaptic connectivity in the brain of a biological organism. The synaptic connectivity graph 406 may be derived directly from a synaptic resolution image of the brain of a biological organism, e.g., as described with reference to FIG. 5. In some cases, the synaptic connectivity graph 406 may be a sub-graph of a larger graph derived from a synaptic resolution image of a brain, e.g., a sub-graph that includes neurons of a particular type, e.g., visual neurons, association neurons.

The system 400 includes a graph generation engine 402, an architecture mapping engine 420, a training engine 414, and a selection engine 418, each of which will be described in more detail next.

The graph generation engine 402 is configured to process the synaptic connectivity graph 406 to generate multiple “candidate” graphs 410, where each candidate graph is defined by a set of nodes and a set of edges, such that each edge connects a pair of nodes. The graph generation engine 402 may generate the candidate graphs 410 from the synaptic connectivity graph 406 using any of a variety of techniques. A few examples follow.

In one example, the graph generation engine 402 may generate a candidate graph 410 at each of multiple iterations by processing the synaptic connectivity graph 406 in accordance with current values of a set of graph generation parameters. The current values of the graph generation parameters may specify (transformation) operations to be applied to an adjacency matrix representing the synaptic connectivity graph 406 to generate an adjacency matrix representing a candidate graph 410. The operations to be applied to the adjacency matrix representing the synaptic connectivity graph may include, e.g., filtering operations, cropping operations, or both. The candidate graph 410 may be defined by the result of applying the operations specified by the current values of the graph generation parameters to the adjacency matrix representing the synaptic connectivity graph 406.

The graph generation engine 402 may apply a filtering operation to the adjacency matrix representing the synaptic connectivity graph 406, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 406 may have the effect of adding edges to the synaptic connectivity graph 406, removing edges from the synaptic connectivity graph 406, or both.

The graph generation engine 402 may apply a cropping operation to the adjacency matrix representing the synaptic connectivity graph 406, where the cropping operation replaces the adjacency matrix representing the synaptic connectivity graph 406 with an adjacency matrix representing a sub-graph of the synaptic connectivity graph 406. Generally, a “sub-graph” may refer to a graph specified by: (i) a proper subset of the nodes of the graph 406, and (ii) a proper subset of the edges of the graph 406. The cropping operation may specify a sub-graph of synaptic connectivity graph 406, e.g., by specifying a proper subset of the rows and a proper subset of the columns of the adjacency matrix representing the synaptic connectivity graph 406 that define a sub-matrix of the adjacency matrix. The sub-graph may include: (i) each edge specified by the sub-matrix, and (ii) each node that is connected by an edge specified by the sub-matrix.

At each iteration, the system 400 determines a performance measure 416 corresponding to the candidate graph 410 generated at the iteration, and the system 400 updates the current values of the graph generation parameters to encourage the generation of candidate graphs 410 with higher performance measures 416. The performance measure 416 for a candidate graph 410 characterizes the performance of an action selection neural network that includes a brain emulation neural network having an architecture specified by the candidate graph 410 at processing at selection actions to be performed by an agent to perform a task in an environment. Determining performance measures 416 for candidate graphs 410 will be described in more detail below. The system 400 may use any appropriate optimization technique to update the current values of the graph generation parameters, e.g., a “black-box” optimization technique that does not rely on computing gradients of the operations performed by the graph generation engine 402. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 402 may generate the candidate graphs 410 by “evolving” a population (i.e., a set) of graphs derived from the synaptic connectivity graph 406 over multiple iterations. The graph generation engine 402 may initialize the population of graphs, e.g., by “mutating” multiple copies of the synaptic connectivity graph 406. Mutating a graph refers to making a random change to the graph, e.g., by randomly adding or removing edges or nodes from the graph. After initializing the population of graphs, the graph generation engine 402 may generate a candidate graph at each of multiple iterations by, at each iteration, selecting a graph from the population of graphs derived from the synaptic connectivity graph and mutating the selected graph to generate a candidate graph 410. The graph generation engine 402 may determine a performance measure 416 for the candidate graph 410, and use the performance measure to determine whether the candidate graph 410 is added to the current population of graphs.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

In another example, the graph generation engine 402 can generate each candidate graph 410 as a sub-graph of the synaptic connectivity graph 406. For example, the graph generation engine 402 can randomly select sub-graphs, e.g., by randomly selecting a proper subset of the rows and a proper subset of the columns of the adjacency matrix representing the synaptic connectivity graph 406 that define a sub-matrix of the adjacency matrix. The sub-graph may include: (i) each edge specified by the sub-matrix, and (ii) each node that is connected by an edge specified by the sub-matrix.

The architecture mapping engine 420 processes each candidate graph 410 to generate a corresponding brain emulation neural network architecture 408. The architecture mapping engine 420 may use the candidate graph 410 derived from the synaptic connectivity graph 406 to specify the brain emulation neural network architecture 408 in any of a variety of ways. For example, the architecture mapping engine 420 may map each node in the candidate graph 410 to a corresponding: (i) artificial neuron, (ii) artificial neural network layer, or (iii) group of artificial neural network layers in the brain emulation neural network architecture 408, as will be described in more detail next.

In one example, the brain emulation neural network architecture 408 can include: (i) a respective artificial neuron corresponding to each node in the candidate graph 410, and (ii) a respective connection corresponding to each edge in the candidate graph 410. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the graph.

An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {αᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the candidate graph 410 can be an undirected graph, and the architecture mapping engine 420 can map an edge that connects a first node to a second node in the graph to two connections between a corresponding first artificial neuron and a corresponding second artificial neuron in the architecture. In particular, the architecture mapping engine 420 can map the edge to: (i) a first connection pointing from the first artificial neuron to the second artificial neuron, and (ii) a second connection pointing from the second artificial neuron to the first artificial neuron.

In another example, the candidate graph 410 can be an undirected graph, and the architecture mapping engine 420 can map an edge that connects a first node to a second node in the graph to one connection between a corresponding first artificial neuron and a corresponding second artificial neuron in the architecture. The architecture mapping engine 420 can determine the direction of the connection between the first artificial neuron and the second artificial neuron, e.g., by randomly sampling the direction in accordance with a probability distribution over the set of two possible directions.

In some cases, the edges in the candidate graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain emulation neural network architecture 408 can include: (i) a respective artificial neural network layer corresponding to each node in the candidate graph, and (ii) a respective connection corresponding to each edge in the candidate graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ(i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h₀(·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping engine 420 can determine that the brain emulation neural network architecture includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The architecture of a brain emulation sub-network can directly represent synaptic connectivity in a region of the brain of the biological organism. More specifically, the system can map the nodes of the candidate graph (which each represent, e.g., a biological neuron in the brain) onto corresponding artificial neurons in the brain emulation sub-network. The system can also map the edges of the candidate graph (which each represent, e.g., a synaptic connection between a pair of biological neurons in the brain) onto connections between corresponding pairs of artificial neurons in the brain emulation sub-network. The system can map the respective weight associated with each edge in the candidate graph to a corresponding weight (i.e., parameter value) of a corresponding connection in the brain emulation sub-network. The weight corresponding to an edge (representing, e.g., a synaptic connection in the brain) between a pair of nodes in the candidate graph (representing a pair of biological neurons in the brain) can represent a proximity of the pair of biological neurons in the brain, as described above.

For each brain emulation neural network architecture 408, the training engine 414 instantiates an action selection neural network 412 implemented as a reservoir computing neural network. The action selection neural network 412 can include a brain emulation sub-network that has the brain emulation neural network architecture 408 and acts as the reservoir. An example action selection neural network that includes a brain emulation sub-network is described in more detail above with reference to FIG. 2. In particular, as described above with reference to FIG. 2, an action selection neural network can include multiple brain emulation sub-networks. Accordingly, the training engine 414 can instantiate multiple action selection neural networks 412 having any appropriate configuration of multiple brain emulation sub-networks. In one example, the training engine 414 can instantiate an action selection neural network having multiple copies of the same brain emulation sub-network. In another example, the training engine 414 can instantiate an action selection neural network having multiple different brain emulation sub-networks, e.g., multiple sub-networks that are each specified by a different candidate graph 410. The training engine 414 can instantiate any appropriate number and configuration of the action selection neural networks, including any appropriate number and configuration of brain emulation sub-networks, and evaluate each action selection neural network at the same agent control task, as will be described in more detail next.

Each action selection neural network 412 is configured to perform an agent control task, e.g., by processing an observation characterizing the current state of the environment at the time step and generating an action selection output characterizing an action to be performed by an agent interacting with an environment. The training engine 414 is configured to train each action selection neural network 412 over multiple training iterations, e.g., in a similar way as described above with reference to FIGS. 1 and 2.

The training engine 414 determines a respective performance measure 416 of each action selection neural network 412 on the agent control task. For example, if the agent is manufacturing robot operating in workcell, the training engine 414 can use each action selection neural network 412 to control the robot to perform a task, e.g., to pick up an object at a first location in the workcell and place the object at a different location in the workcell. The training engine 414 can then determine a performance measure 416 for each action selection neural network based on a cumulative measure (e.g., sum) of rewards received when the robot is controlled by the action selection neural network. In other words, the training engine 414 can evaluate how successful each agent, controlled by each respective action selection neural network 412, is in accomplishing the task. In some implementations, the agent can be a simulated manufacturing robot interacting with a simulated workcell, and each action selection neural network 412 can be used to control the simulated robot in accomplishing the task in the simulated workcell. The training engine 414 can determine the performance measure 416 for each action selection neural network 412 based on how well each simulated agent performs the task.

The selection engine 418 uses the performance measures 416 to generate the output brain emulation neural network 404. In one example, the selection engine 418 may generate a brain emulation neural network 404 having the brain emulation neural network architecture 408 associated with the best (e.g., highest) performance measure 416. Continuing with the manufacturing robot example, the selection engine 418 can select the brain emulation neural network architecture that was most successful in controlling the simulated robot in accomplishing the simulated task, e.g., the architecture with the highest performance measure, and generate an action selection neural network that includes the corresponding brain emulation neural network 404. The action selection neural network can then be used to control a physical manufacturing robot in a physical workcell to accomplish tasks. In some implementations, the action selection neural network can enable the physical robot to perform new tasks in new (e.g., previously unseen) environments. For example, the action selection neural network can control the physical robot in a different physical workcell.

As another example, the training engine 414 may determine the performance measure 416 for each action selection neural network 412 based on a respective error between: (i) the output generated by the action selection neural network 412 for the observation, and (ii) a target output for the observation, for each observation in one or more expert trajectories. An expert trajectory can define interaction of the agent with the environment when the agent is controlled by an “expert,” e.g., a human expert, to perform a task. For example, the target output for an observation in an expert trajectory can define an action selected by the expert in response to the observation. The training engine 414 may determine the performance measure 416, e.g., as the average error or the maximum error over respective sets of expert trajectories.

As described above, the brain emulation neural network architecture can be specified by a synaptic connectivity graph that represents the structure of synaptic connections in the brain of the biological organism. The synaptic connectivity graph can be obtained from a synaptic resolution image of the brain of the biological organism, as will be described in more detail next.

FIG. 5 is an example data flow 500 for generating a synaptic connectivity graph 503 from a synaptic resolution image 503 of the brain 504 of a biological organism. An imaging system 502 can be used to generate a synaptic resolution image 503 of the brain 504. An image of the brain 504 can be referred to as having synaptic resolution if it has a spatial resolution that is sufficiently high to enable the identification of at least some synapses in the brain 504. Put another way, an image of the brain 504 can be referred to as having synaptic resolution if it depicts the brain 504 at a magnification level that is sufficiently high to enable the identification of at least some synapses in the brain 504. The image 503 can be a volumetric image, i.e., that characterizes a three-dimensional representation of the brain 504. The image 503 can be represented in any appropriate format, e.g., as a three-dimensional array of numerical values.

The imaging system 502 can be any appropriate system capable of generating synaptic resolution images, e.g., an electron microscopy system. The imaging system 502 can process “thin sections” from the brain 504 (i.e., thin slices of the brain attached to slides) to generate output images that each have a field of view corresponding to a proper subset of a thin section. The imaging system 502 can generate a complete image of each thin section by stitching together the images corresponding to different fields of view of the thin section using any appropriate image stitching technique. The imaging system 502 can generate the volumetric image 503 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 630-743 (2018).

In some implementations, the imaging system 502 can be a two-photon endomicroscopy system that utilizes a miniature lens implanted into the brain to perform fluorescence imaging. This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 507 is configured to process the synaptic resolution image 503 to generate the synaptic connectivity graph 506. The synaptic connectivity graph 506 specifies a set of nodes and a set of edges, such that each edge connects two nodes. To generate the graph 506, the graphing system 507 identifies each neuron in the image 503 as a respective node in the graph, and identifies each synaptic connection between a pair of neurons in the image 503 as an edge between the corresponding pair of nodes in the graph.

The graphing system 507 can identify the neurons and the synapses depicted in the image 503 using any of a variety of techniques. For example, the graphing system 507 can process the image 503 to identify the positions of the neurons depicted in the image 503, and determine whether a synapse connects two neurons based on the proximity of the neurons (as will be described in more detail below). In this example, the graphing system 507 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 507 can identify contiguous clusters of voxels in the neuron probability map as being neurons.

Optionally, prior to identifying the neurons from the neuron probability map, the graphing system 507 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 507 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 503 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 507 can identify the synapses connecting the neurons in the image 503 based on the proximity of the neurons. For example, the graphing system 507 can determine that a first neuron is connected by a synapse to a second neuron based on the area of overlap between: (i) a tolerance region in the image around the first neuron, and (ii) a tolerance region in the image around the second neuron. That is, the graphing system 507 can determine whether the first neuron and the second neuron are connected based on the number of spatial locations (e.g., voxels) that are included in both: (i) the tolerance region around the first neuron, and (ii) the tolerance region around the second neuron. For example, the graphing system 507 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 507 can further identify a weight value associated with each edge in the graph 506. For example, the graphing system 507 can identify a weight for an edge connecting two nodes in the graph 506 based on the area of overlap between the tolerance regions around the respective neurons corresponding to the nodes in the image 503. The area of overlap can be measured, e.g., as the number of voxels in the image 503 that are contained in the overlap of the respective tolerance regions around the neurons. The weight for an edge connecting two nodes in the graph 506 can be understood as characterizing the (approximate) strength of the connection between the corresponding neurons in the brain (e.g., the amount of information flow through the synapse connecting the two neurons).

In addition to identifying synapses in the image 503, the graphing system 507 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 507 determines the directions of the synapses in the image 503, the graphing system 507 can associate each edge in the graph 506 with the direction of the corresponding synapse. That is, the graph 506 can be a directed graph. In other implementations, the graph 506 can be an undirected graph, i.e., where the edges in the graph are not associated with a direction.

The graph 506 can be represented in any of a variety of ways. For example, the graph 506 can be represented as a two-dimensional array of numerical values with a number of rows and columns equal to the number of nodes in the graph. The component of the array at position (i, j) can have value 1 if the graph includes an edge pointing from node i to node j, and value 0 otherwise. In implementations where the graphing system 507 determines a weight value for each edge in the graph 506, the weight values can be similarly represented as a two-dimensional array of numerical values. More specifically, if the graph includes an edge connecting node i to node j, the component of the array at position (i, j) can have a value given by the corresponding edge weight, and otherwise the component of the array at position (i, j) can have value 0.

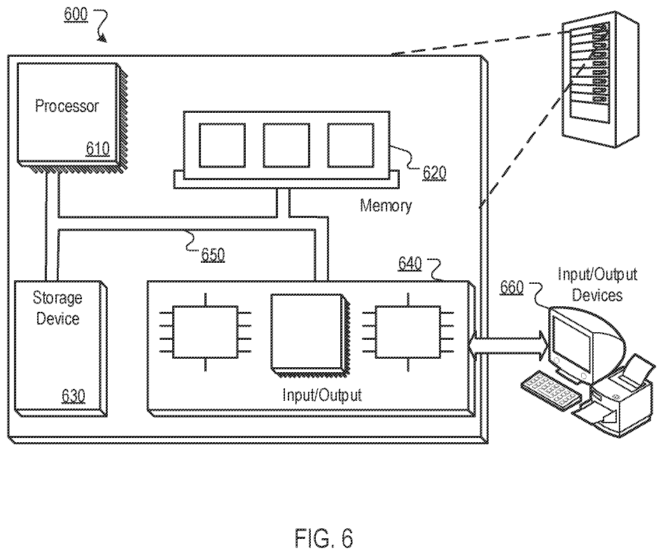

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus for selecting actions to be performed by an agent interacting with an environment, the method comprising, at each of a plurality of time steps:
receiving an observation characterizing a current state of the environment at the time step;
providing an input comprising the observation characterizing the current state of the environment at the time step to an action selection neural network having a brain emulation sub-network with an architecture that is based on synaptic connectivity between biological neurons in a brain of a biological organism;
processing the input comprising the observation characterizing the current state of the environment at the time step using the action selection neural network having the brain emulation sub-network to generate an action selection output; and
selecting an action to be performed by the agent at the time step based on the action selection output.

2. The method of claim 1, wherein the environment is a simulated environment and the agent is a simulated agent interacting with the simulated environment.

3. The method of claim 2, wherein the simulated agent is a simulated neuro-mechanical model of an organism.

4. The method of claim 2, wherein the simulated agent is a simulated robot.

5. The method of claim 1, wherein the action selection output comprises a respective score for each action in a set of possible actions that can be performed by the agent.

6. The method of claim 5, wherein selecting the action to be performed by the agent at the time step based on the action selection output comprises:
determining a probability distribution over the set of possible actions based on the scores for the actions defined by the action selection output; and
sampling the action to be performed by the agent at the time step from the probability distribution over the set of possible actions.

7. The method of claim 1, further comprising:
receiving a respective reward for each of the plurality of time steps; and
training the action selection neural network based on the rewards using a reinforcement learning technique.

8. The method of claim 7, wherein the reinforcement learning technique is a Q learning technique.

9. The method of claim 7, wherein for each of the plurality of time steps, processing the input comprising the observation characterizing the current state of the environment at the time step using the action selection neural network comprises:
processing the input comprising the observation using a first sub-network of the action selection neural network to generate a first sub-network output;
processing the first sub-network output using the brain emulation sub-network to generate a brain emulation sub-network output; and
processing the brain emulation sub-network output using a second sub-network of the action selection neural network to generate the action selection output.

10. The method of claim 9, wherein parameter values of the brain emulation sub-network are initialized prior to training of the action selection neural network and are not adjusted during the training of the action selection neural network, and wherein at least some parameter values of the first sub-network, the second sub-network, or both, are adjusted during the training of the action selection neural network.

11. The method of claim 1, wherein the action selection neural network comprises a plurality of brain emulation sub-networks that each have a respective architecture that is based on synaptic connectivity between biological neurons in the brain of the biological organism.

12. The method of claim 1, wherein the brain emulation neural network architecture is determined from a synaptic connectivity graph that represents the synaptic connectivity between the biological neurons in the brain of the biological organism.

13. The method of claim 12, wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

14. The method of claim 13, wherein the synaptic connectivity graph is generated by a plurality of operations comprising:
obtaining a synaptic resolution image of at least a portion of the brain of the biological organism; and
processing the image to identify: (i) a plurality of neurons in the brain, and (ii) a plurality of synaptic connections between pairs of neurons in the brain.

15. The method of claim 13, wherein determining the brain emulation neural network architecture from the synaptic connectivity graph comprises:
mapping each node in the synaptic connectivity graph to a corresponding artificial neuron in the brain emulation neural network architecture; and
mapping each edge in the synaptic connectivity graph to a connection between a corresponding pair of artificial neurons in the brain emulation neural network architecture.

16. The method of claim 15, wherein determining the brain emulation neural network architecture from the synaptic connectivity graph further comprises:
instantiating a respective parameter value associated with each connection between a pair of artificial neurons in the brain emulation neural network architecture that is based on a respective proximity between a corresponding pair of biological neurons in the brain of the biological organism.

17. The method of claim 13, wherein determining the brain emulation neural network architecture from the synaptic connectivity graph comprises:
generating data defining a plurality of candidate graphs based on the synaptic connectivity graph;
determining a respective performance measure for each candidate graph, comprising, for each candidate graph:
instantiating an instance of an action selection neural network having a sub-network with an architecture that is specified by the candidate graph; and
determining the performance measure for the candidate graph based on a task performance of an agent that accomplishes a task in an instance of an environment by performing actions selected using the instance of the action selection neural network having the sub-network with the architecture that is specified by the candidate graph; and
selecting the brain emulation neural network architecture based on the performance measures.

18. The method of claim 17, wherein selecting the brain emulation neural network architecture based on the performance measures comprises:
identifying a best-performing candidate graph that is associated with a highest performance measure from among the plurality of candidate graphs; and
selecting the brain emulation neural network architecture to be an artificial neural network architecture specified by the best-performing candidate graph.

19. One or more non-transitory computer storage media storing instructions that when executed by one or more computers cause the one or more computers to perform operations for selecting actions to be performed by an agent interacting with an environment, the operations comprising, at each of a plurality of time steps:
receiving an observation characterizing a current state of the environment at the time step;
providing an input comprising the observation characterizing the current state of the environment at the time step to an action selection neural network having a brain emulation sub-network with an architecture that is based on synaptic connectivity between biological neurons in a brain of a biological organism; and
processing the input comprising the observation characterizing the current state of the environment at the time step using the action selection neural network having the brain emulation sub-network to generate an action selection output; and
selecting an action to be performed by the agent at the time step based on the action selection output.

20. A system comprising:
one or more computers; and
one or more storage devices communicatively coupled to the one or more computers, wherein the one or more storage devices store instructions that, when executed by one or more computers, cause one or more computers to perform operations for selecting actions to be performed by an agent interacting with an environment, the operations comprising, at each of a plurality of time steps:
receiving an observation characterizing a current state of the environment at the time step;
providing an input comprising the observation characterizing the current state of the environment at the time step to an action selection neural network having a brain emulation sub-network with an architecture that is based on synaptic connectivity between biological neurons in a brain of a biological organism; and
processing the input comprising the observation characterizing the current state of the environment at the time step using the action selection neural network having the brain emulation sub-network to generate an action selection output; and
selecting an action to be performed by the agent at the time step based on the action selection output.
